(19) United States
(12) Patent Application Publication
(10) Pub. No.: US 2013/0111775 A1
(43) Pub. Date: May 9, 2013

(54) FRAMING TOOL

(71) Applicant: Mark Kevin Davis, Caarlw Rock, CO (US)

(72) Inventor: Mark Kevin Davis, Caarlw Rock, CO (US)

(21) Appl. No.: 13/462,121

(22) Filed: May 2, 2012

Related U.S. Application Data
(63) Continuation of application No. 12/723,639, filed on Mar. 13, 2010, now Pat. No. 8,191,335.

(51) Int. Cl. G01B 5/24

(52) U.S. Cl. 33/613

(57) ABSTRACT

A multi-sided framing tool includes a stud side with stud pockets, a nail side with nailing windows, and an intermediate side adjoining the stud and nail sides.

### PRIORITY CLAIM

This application is a continuation of U.S. patent application Ser. No. 12/723,639 filed Mar. 13, 2010 and entitled FRAMING GUIDE.

### BACKGROUND OF THE INVENTION

1. Field of the Invention

The present invention relates to a construction tool. In particular, a framing tool or guide provides a means for improved construction, including improved wall construction.

2. Discussion of the Related Art

Construction using framing members is an old art. Over hundreds of years, the tools, materials, and methods used for framing structures have improved. Despite these improvements, framing tools used today are little changed from those used hundreds of years ago. The most significant improvements relate primarily to mechanizing a well known tool, such as substituting a nail gun for a hammer and nail.

### SUMMARY OF THE INVENTION

A framing tool comprises a guide used to align a horizontal framing member with a vertical framing member and to facilitate fastening the members together while maintaining the desired relative alignment.

In an embodiment, an elongated framing guide has a stud side coupled to an opposed nail side by an intermediate side. The stud side, intermediate side, and nail side form a substantially “n” shaped guide cross section with an elongated slot. The elongated slot is for receiving a horizontal framing member.

The stud side includes a plurality of pockets for receiving respective ends of vertical framing members and each pocket has three sides formed to position opposing major sides of the vertical framing member about perpendicular to the intermediate side. A leveling device is located between each pair of adjacent pockets and is arranged to indicate a level of the guide.

The nail side includes a plurality of nailing windows and each nailing window is generally opposed to a respective stud side pocket.

The intermediate side includes a plurality of insets, each inset located between an adjacent pair of the stud side pockets. Each inset has a surface depressed with respect to the intermediate side and about parallel to the intermediate side and a plurality of the depressed surfaces have respective leveling devices, each leveling device located between an adjacent pair of pockets and arranged to indicate a level of the guide. The intermediate side further includes a plurality of viewing windows, each viewing window for exposing a junction between a vertical framing member and the horizontal framing member.

The guide is movable along an upper horizontal framing member of arbitrary length for aiding alignment and fixation of vertical framing members with the upper horizontal framing member. In addition, the guide is movable along an associated lower horizontal framing member for aiding alignment and fixation of the vertical framing members with the lower horizontal framing member.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1A shows a framing guide in accordance with the present invention.

FIG. 1B shows hinged embodiment of the framing guide of FIG. 1.

FIG. 2 shows another view of the framing guide of FIG. 1.

FIG. 3 shows the framing guide of FIG. 1 alongside framing members to be assembled using the guide.

FIG. 4 shows a cross-section of a selected portion of the guide of FIG. 1.

FIG. 5 shows a flowchart depicting an exemplary method of using the guide of FIG. 1.

FIG. 6 shows construction of a wall section using the guide of FIG. 1.

FIG. 7 shows placement and leveling of a wall section using the guide of FIG. 1.

### DETAILED DESCRIPTION OF THE PREFERRED EMBODIMENTS

The disclosure provided in the following pages describes examples of some embodiments of the invention. The designs, figures, and description are non-limiting examples of the embodiments they disclose. For example, other embodiments of the disclosed device and/or method may or may not include the features described herein. Moreover, disclosed advantages and benefits may apply to only certain embodiments of the invention and should not be used to limit the disclosed invention.

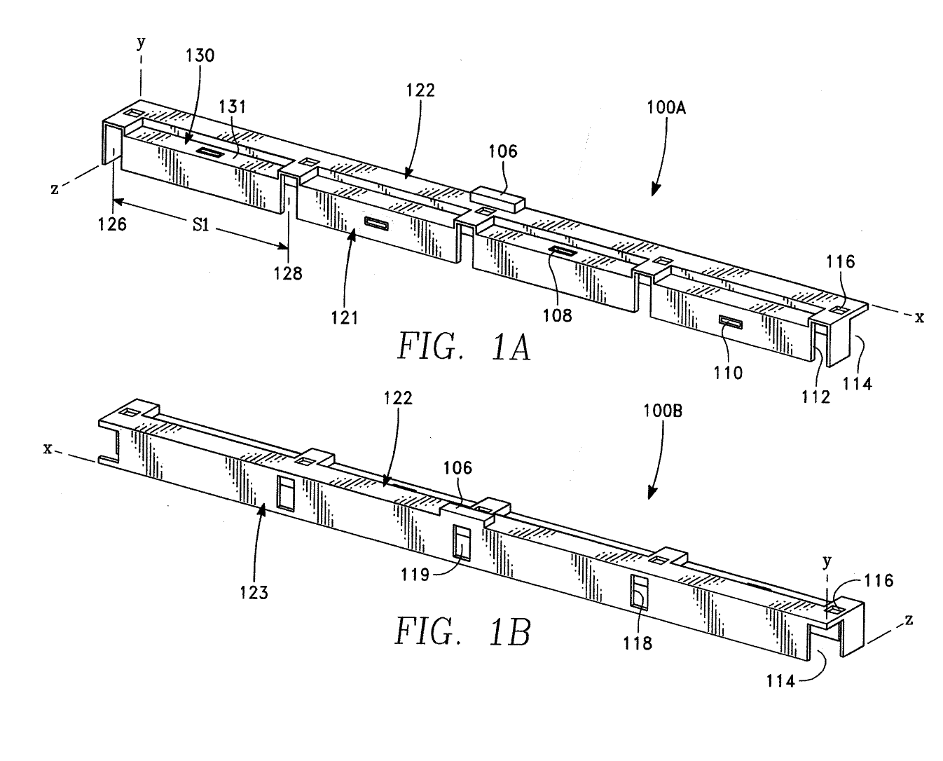

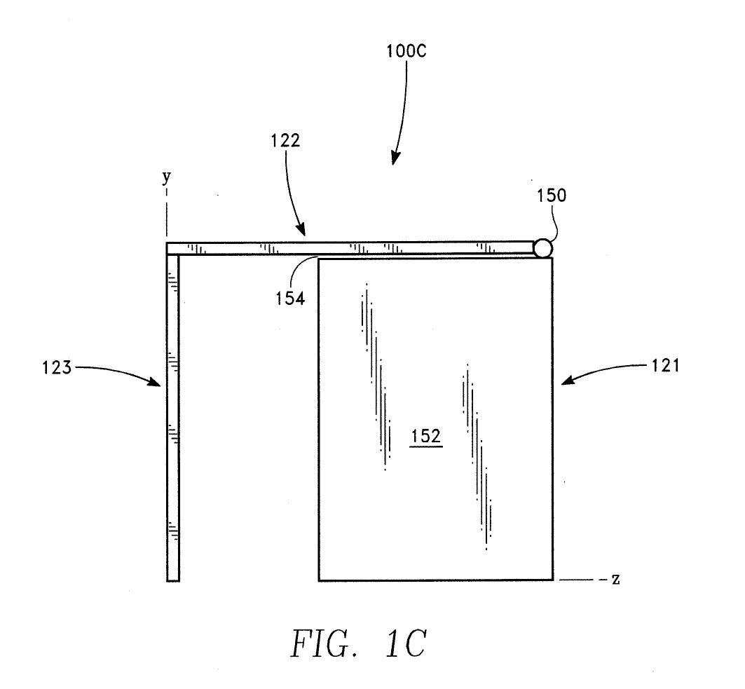

FIG. 1A shows a framing guide in accordance with the present invention 100A. A first view of the guide 102 shows a guide stud side 121 and a guide intermediate side 122. A second view of the guide 104 shows a guide nail side 123 and the guide intermediate side. The guide has a generally “n” shaped cross-section formed by the stud side, intermediate side, and nail side. FIG. 1B shows a framing guide having an articulated joint 100B.

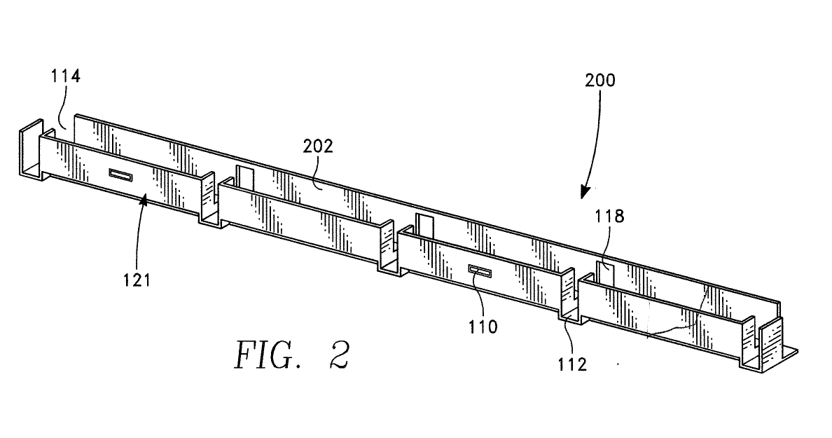

FIG. 2 shows an axially rotated view of the guide 200. In the axially rotated view, the open side of the “n” shaped guide 202 is visible.

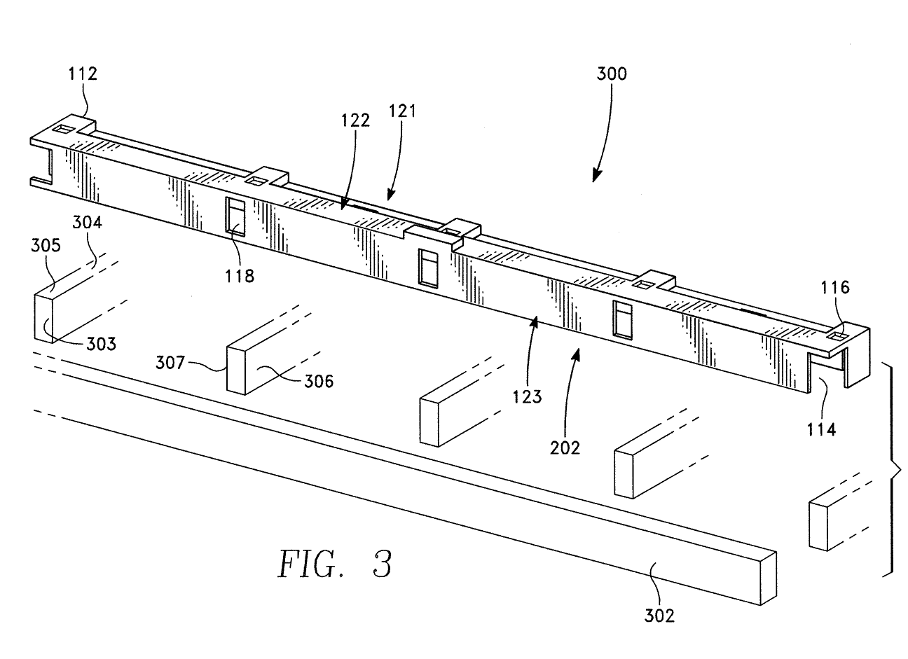

FIG. 3 shows the guide and framing members to be joined 300. The framing members include a horizontal framing member 302 and a plurality of vertical framing members or studs 304.

An orthogonal coordinate system with an origin at a lower, back, left corner of the guide as shown in the first view 102 places the stud side 121 in a plane parallel to the x-y plane, the nail side 123 in a plane parallel to the x-y plane, the intermediate side 122 in a plane parallel to the x-z plane, and the open side 202 in a plane parallel to the x-z plane.

Stud pockets 112 are arranged along the stud side 121 of the framing guide. In an embodiment, the framing guide has five stud pockets (as shown). Some embodiments utilize less than five stud pockets while other embodiments utilize more than five stud pockets. Each stud pocket has three sides formed to position opposing major sides of the studs 306, 307. Spacing between the stud pocket centerlines 126, 128 is set to create a desired stud spacing 51 such as 12 inches on center, 18 inches on center, or another desired spacing.

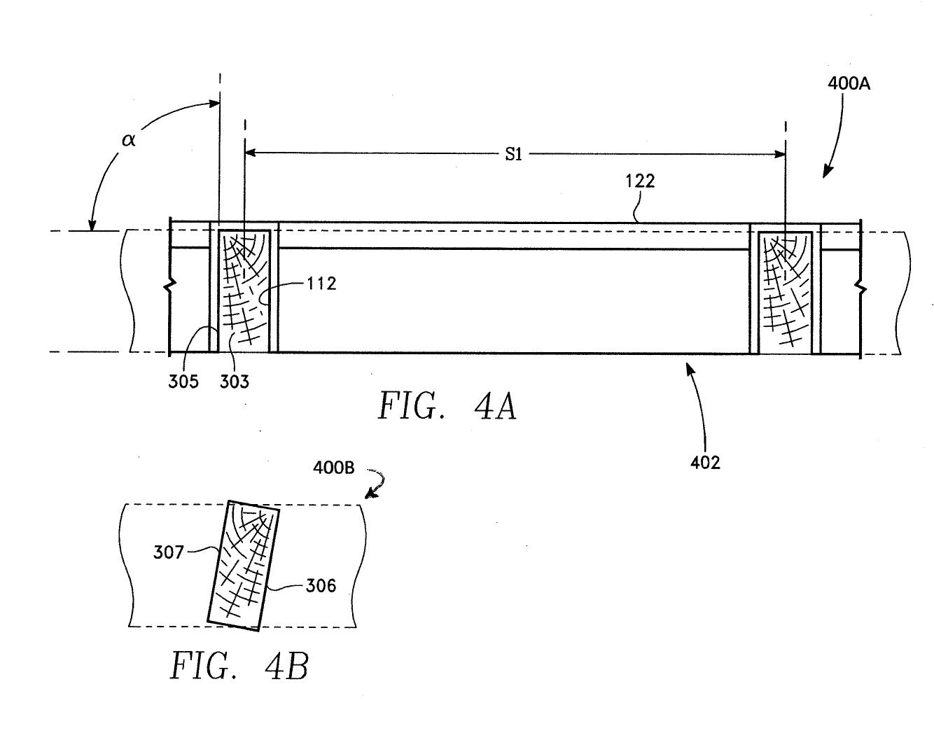

FIG. 4 shows framing guide cross-section along a plane parallel to the x-y plane 400. The stud ends 305 are inserted in the stud pockets 112. As can be seen in the first view 402, the framing guide aligns the stud major sides 306, 307 about perpendicular to the intermediate side 122. In contrast, assembly without the framing guide often leads to misaligned studs as shown in the second view 404.

In an embodiment, one or more bubble tube type levels 108 are fixed to the intermediate side 122 between adjacent stud pockets 112 (as shown). These levels lie along a line parallel to the x axis and are referred to as x-z levels. In some embodiments, one or more bubble type levels 110 are fixed to the stud side 121 between adjacent stud pockets 112 (as shown). These levels lie along a line parallel to the x axis and are referred to as x-y levels.

In an embodiment, adjacent stud pockets 112 are separated by insets 130 (as shown). Here, each inset has a surface 131 depressed with respect to the intermediate side 122 and about parallel to the intermediate side. Where the framing guide material is chosen for properties other than strength and rigidity, such as in the choice of a light weight polymeric or plastic material, the use of insets improves the rigidity of the guide.

Nailing windows 118 are arranged along the nail side 123 of the framing guide. In an embodiment, the framing guide has five nailing windows (as shown). Nailing windows correspond to stud pockets 112 as further described below. Each nailing window provides an opening into the interior of the framing guide 119 that aligns with a respective stud pocket and stud face 303.

An elongated slot 114 along the length of the framing guide is for interengaging a horizontal framing member 302 (see FIG. 3). One side of the slot is bounded by the framing guide's nail side 123 and an adjacent side of the slot is bounded by the framing guide's intermediate side 122.

In an embodiment, viewing windows 116 are arranged along the intermediate side of the framing guide. The viewing windows are aligned with the stud pockets 112. When the framing guide interengages a horizontal framing member 302 and a stud 304, the corresponding viewing window enables a user to view the junction where the stud meets the horizontal framing member. Visual assessments of these junctions enable a user to assure, among other things, that a stud is fully inserted in a respective stud pocket 112.

Some framing guide embodiments provide a hand-hold means to facilitate handling the guide. In one embodiment, a hand hold 106 extends from the intermediate side 122 about midway between the ends of the framing guide. And, some framing guide embodiments provide a hinge 150 (See FIG. 1B) coupling the stud and intermediate sides 121, 122, rotation of the stud side with respect to the intermediate side being useful for facilitating sliding the guide along a horizontal framing member. In a hinged embodiment, end walls 152 are separated from the intermediate side by a gap 154 enabling rotation of the end walls and stud side with respect to the intermediate side.

In various embodiments, the framing guide is made of one or more materials that provide the desired combination of strength, rigidity, light weight, manufacturability, and toughness. Non-metal materials include polymers such as plastics, composites such as carbon composites, and fabric with resin composites such as fiberglass. Metals include ferrous and non-ferrous metals such as steel, aluminum, titanium, and alloys of these metals known to persons of ordinary skill in the art.

In operation, the framing guide is used to align a horizontal framing member 302 with a plurality of vertical framing members 304, and to facilitate fastening the members together.

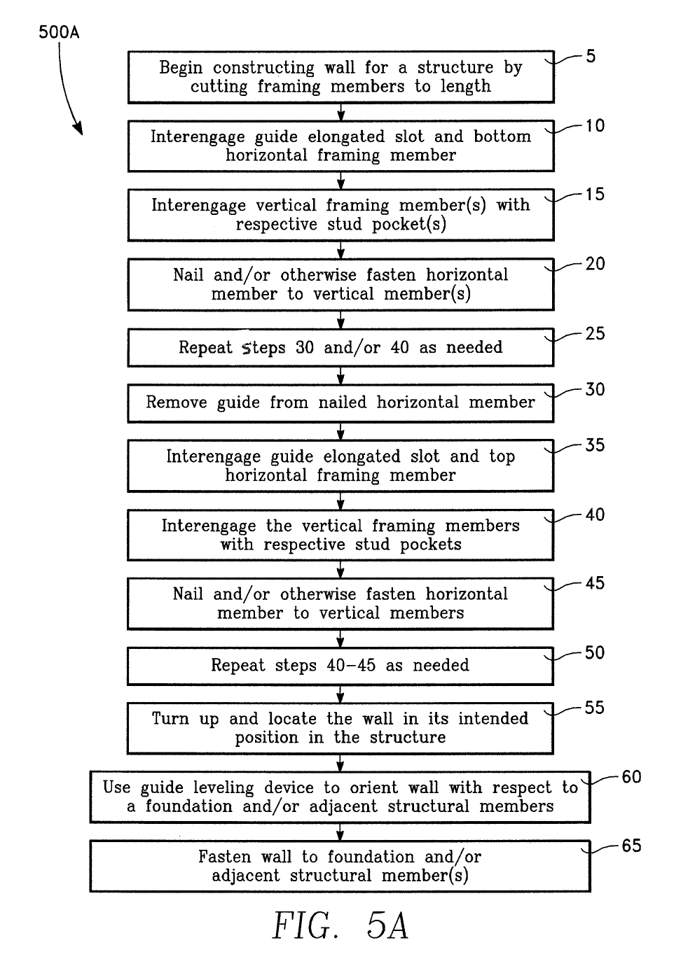

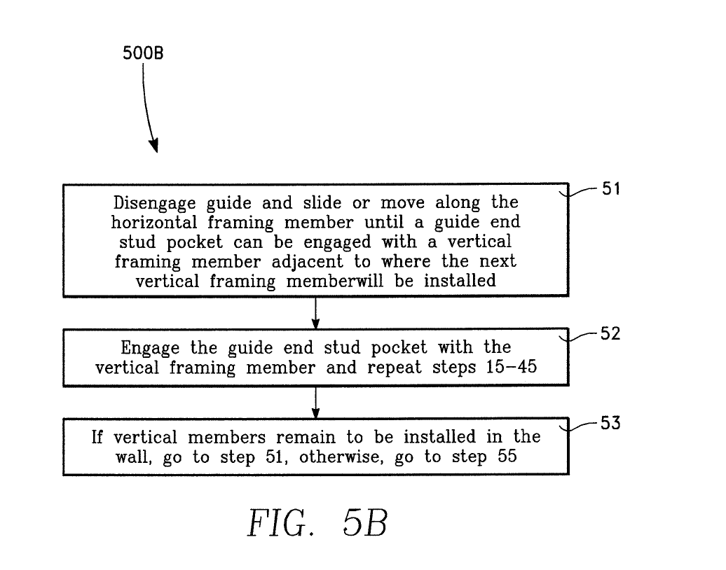

FIG. 5 shows an exemplary method of using the framing guide 500. The method steps may be in the sequence shown, or in another sequence and fewer than all of the steps may be used in various embodiments. Moreover, other steps may be included as will be understood by a person of ordinary skill in the art.

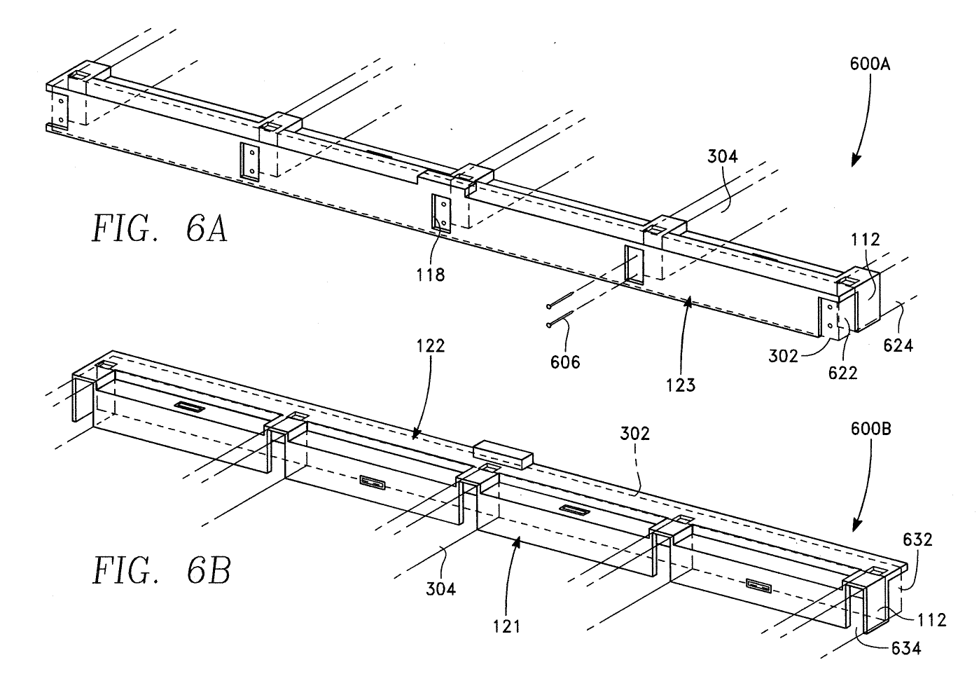

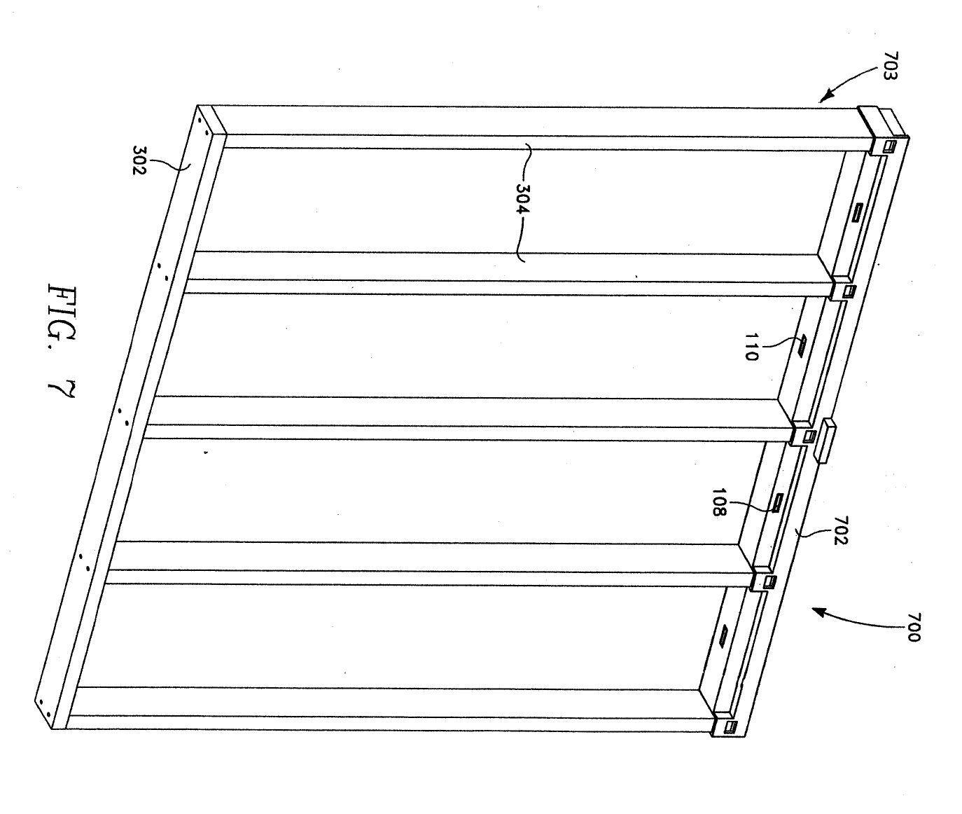

FIG. 6 shows the framing guide in use during wall section construction 600. View 602 shows fastening of a bottom horizontal member 622 and view 604 shows fastening of a top horizontal member 632. FIG. 7 shows the framing guide in use during wall section placement 700. The framing guide 702 is located atop the wall section 703 and levels 108, 110 are available for leveling of the wall section.

In the exemplary sequence of method steps, a wall is constructed using the framing guide. In step 5, framing members are selected and cut to length as needed 300. In step 10, the guide elongated slot 114 is interengaged with a bottom horizontal framing member 612. In step 15 vertical framing members are interengaged with respective stud pockets 624. In step 20, fasteners such as nails, screws, staples, or another fastener known to persons of ordinary skill in the art are used to fasten the horizontal member to the vertical members 606 via the nailing windows 118. In step 25, steps 15 and/or 20 are repeated as needed to fasten each vertical framing member to the horizontal framing member 25.

In step 35, when the studs 304 in the framing guide are fastened to the bottom horizontal member 622, the framing guide is removed from the fastened framing members 30 and the framing guide elongated slot is interengaged with a top horizontal framing member. In step 40 the opposite ends of the vertical framing members interengaged with respective stud pockets 634. In step 45, fasteners such as nails, screws, staples, or another fastener known to persons of ordinary skill in the art are used to fasten the horizontal member to the vertical members 606 via the nailing windows 118. In step 50, steps 40 and/or 45 are repeated as needed to fasten each vertical framing member to the horizontal framing member.

In step 55, when the studs 304 in the framing guide are fastened to the top horizontal member 632, the constructed wall 700 is turned up and located in its intended position in a structure. In step 60, the leveling devices 108, 110 are used to orient the wall with respect to a foundation and/or adjacent structural members. In step 65, when the wall is positioned and leveled as desired, the wall is fastened to the foundation and/or adjacent structural members.

In an embodiment, the framing guide is used to construct a wall section incorporating more studs than can be placed in the framing guide at one time. Here, the framing guide is moved along a horizontal framing member to incorporate additional studs. An exemplary method incorporates additional steps 51, 52, and 53 between steps 50 and 55.

After step 45 disengage the guide and slide or move it along the horizontal framing member until a guide end stud pocket can be engaged with a vertical framing member adjacent to where the next framing member will be installed 51. Engage the guide end stud pocket with the vertical framing member and repeat steps 15-45. In step 53, if vertical members remain to be installed in the wall, go to step 51; otherwise, go to step 55.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A framing tool comprising:
an elongated guide having a stud side coupled to a nail side by an intermediate side;
the stud side, intermediate side, and nail side forming a substantially “n” shaped guide cross-section and an elongated slot;
the elongated slot for receiving a horizontal framing member;
the stud side including a plurality of pockets for receiving respective ends of vertical framing members;
the nail side including a plurality of nailing windows;
the guide being relocatable along an upper horizontal framing member of arbitrary length for aiding alignment and fixation of vertical framing members with the upper horizontal framing member; and,
the guide being relocatable along an associated lower horizontal framing member for aiding alignment and fixation of the vertical framing members with the lower horizontal framing member.

2. The framing tool of claim 1 wherein each nailing window is opposite a respective pocket.

3. The framing tool of claim 1 wherein the vertical framing members are wall studs.

4. The framing tool of claim 1 wherein the stud side is opposite the nail side.

5. The framing tool of claim 4 wherein each pocket has three closed sides and an open side formed to position opposing major sides of the vertical framing member with respect to the intermediate side.

6. The framing tool of claim 5 further including a first plurality of leveling devices including a leveling device located between each adjacent pair of pockets in a plane substantially parallel to the stud side, the leveling guide arranged to indicate a level of the guide.

7. The framing tool of claim 6 wherein a plurality of nailing windows are generally opposed by respective stud side pockets.

8. A framing tool for guiding joining horizontal and vertical framing members, the framing tool comprising:
an elongated guide having a stud side coupled to a nail side by an intermediate side;
the stud side, intermediate side, and nail side forming a substantially “n” shaped guide cross-section and an elongated slot;
the elongated slot for receiving a horizontal framing member;
the stud side including a plurality of pockets for receiving respective ends of vertical framing members;
the nail side including a plurality of nailing windows operative to provide access for nailing together horizontal and vertical framing members;
the guide being relocatable along an upper horizontal framing member of arbitrary length for aiding alignment and fixation of vertical framing members with the upper horizontal framing member; and,
the guide being relocatable along an associated lower horizontal framing member for aiding alignment and fixation of the vertical framing members with the lower horizontal framing member.

9. The framing tool of claim 8 further comprising an elongated slot dimension that is greater than the horizontal framing member length wherein the horizontal framing member is for engaging three or more wall studs spaced twelve or more inches on center.

10. The framing tool of claim 8 further comprising nailing windows that are spaced to accommodate vertical framing members that are spaced twelve or more inches on center.

11. The framing tool of claim 8 further comprising a plurality of opposed pairs of pocket sidewalls for guiding vertical framing members.

12. The framing tool of claim 8 further comprising a plurality of pocket mouths opposite respective nailing windows.

13. The framing tool of claim 8 further comprising a plurality of opposed pairs of pocket sidewalls, the pocket sidewalls lying in parallel planes.
